(19) United States
(12) Patent Application Publication
(10) Pub. No.: US 2006/0160623 A1
(43) Pub. Date: Jul. 20, 2006

(54) Method for implementing game function in mobile terminal

(75) Inventor: Chang-Woo Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/296,361

(22) Filed: Dec. 8, 2005

(30) Foreign Application Priority Data
Dec. 29, 2004 (KR) 2004-115416

(51) Int. Cl. A63F 13/00

(52) U.S. Cl. 463/42

(57) ABSTRACT

A method and apparatus for implementing a multi-user game function on a plurality of mobile terminals equipped with a LAN module. The method includes the steps of detecting when a key for playing a multi-user game using a LAN is pressed and in response, setting a connection between the plurality of mobile terminals and implementing the game function, sending game information generated during the game to each mobile terminal and storing the game information, and applying the stored game information for the next round of game play.

### CROSS-REFERENCE TO RELATED APPLICATIONS

This application claims the benefit under 35 U.S.C. §119(a) of Korean Patent Application No. 10-2004-0115416 entitled “Method For Implementing Game Function In Mobile Terminal”, filed in the Korean Intellectual Property Office on Dec. 29, 2004, the entire disclosure of which is incorporated herein by reference.

### BACKGROUND OF THE INVENTION

1. Field of the Invention

The present invention relates to a method and apparatus for implementing a game function in a mobile terminal. More particularly, the present invention relates to a method and apparatus for implementing a multi-user game using a LAN and applying game information generated during the game for the next round of game play.

2. Description of the Related Art

Mobile communication terminals are becoming more integrated than existing mobile telephones for voice communication to perform high-speed data transmission. For example, IMT-2000 mobile communication network services enable high-speed data transmission as well as voice communication through mobile terminals. That is, mobile terminals can now process both packet data and image data in an IMT-2000 network.

Mobile terminals equipped with a camera or a TV receiver can also display moving pictures. For example, mobile terminals having an embedded camera can take pictures and display them as moving or still pictures. Also, it is possible to send the pictures to another mobile terminal. Still other mobile terminals having a TV receiver can display received video or image signals.

Such multifunctional mobile terminals can further have a game function that enables users to play a variety of online games. Online games that are available on a mobile terminal are broadly divided into single-user games and multi-user games. A single-user game is played by a single user according to a preset rule. Only the single user can enjoy the game using a game program embedded in the mobile terminal without communicating with another mobile terminal. Since single-user games are relatively simple and monotonous, users may easily become bored with the games and lose interest in playing alone once they become familiar with the game rules. Multi-user games that are played by two or more users online at the same time are more exciting and more effectively sustain the users' interest. Therefore, the multi-user game function is becoming more popular with users of mobile terminals.

Generally, a local area network (LAN) such as Bluetooth is used in multi-user games on mobile terminals so that multiple users without Internet access can participate in the games at the same time.

However, when an online game using a local area network is completed or ended, information such as each user's score or level obtained in the game is not stored or applied in the next game. Since the next game is started with a preset default score or level rather than with the score or level obtained in the previous game, individual users may still become bored and loose interest in the game.

Accordingly, a need exists for a method and apparatus for providing multi-user game play wherein game information generated during the game can be stored and applied for the next round of game play.

### SUMMARY OF THE INVENTION

Accordingly, embodiments of the present invention have been made to substantially solve the above-mentioned and other problems occurring in the prior art. An object of the present invention is to provide a method and apparatus for implementing a multi-user game function to enable multiple users to participate in a multi-user game on their mobile terminals using a local area network, providing game information generated during the game to each user's mobile terminal when the game ends, and storing the game information to be applied for the next round of game play.

In order to accomplish the above and other objects of the present invention, a method is provided for implementing a multi-user game function on a plurality of mobile terminals equipped with a LAN module, which comprises the steps of detecting when a key for playing a multi-user game using a LAN is pressed and in response, setting a connection between the plurality of mobile terminals and implementing the game function, sending game information generated during the game to each mobile terminal and storing the game information, and applying the stored game information for a next round of game play.

### BRIEF DESCRIPTION OF THE DRAWINGS

The above and other objects, features and advantages of the present invention will become more apparent from the following detailed description taken in conjunction with the accompanying drawings, in which:

FIG. 1 is a view illustrating a configuration of a system for a multi-user game played by users of different mobile terminals using a local area network according to an embodiment of the present invention;

FIG. 2 is a block diagram of a mobile terminal according to an embodiment of the present invention;

FIG. 3A is a signal exchange flow chart illustrating a process for exchanging game information between each mobile terminal that has participated in the game and for storing the game information according to an embodiment of the present invention;

FIG. 3B is a flow chart illustrating a process for exchanging game information between each mobile terminal that has participated in the game and for storing the game information according to an embodiment of the present invention; and

FIG. 4 is a flow chart illustrating a process for implementing a game function on a mobile terminal according to an embodiment of the present invention.

Throughout the drawings, like reference numerals will be understood to refer to like parts, components and structures.

### DETAILED DESCRIPTION OF THE EXEMPLARY EMBODIMENTS

Hereinafter, exemplary embodiments of the present invention will be described with reference to the accompanying drawings. In the following description of embodiments of the present invention, a detailed description of known functions and configurations incorporated herein will be omitted when it may make the subject matter of the present invention unclear.

The term “game information” used herein refers to various information generated during a game, which comprises a player's ID (for example, a mobile phone number, mobile phone user's name, user's image and/or icon), a score or level obtained in the game, game start/end times and any game condition changed during the game. A local area network used in a multi-user game can be implemented by Bluetooth, Infrared Data Association (IrDA) or Ultra Wide Band (UWB) technologies. In the following description, Bluetooth will be explained as an example local area network, but embodiments of the present invention are not limited thereto.

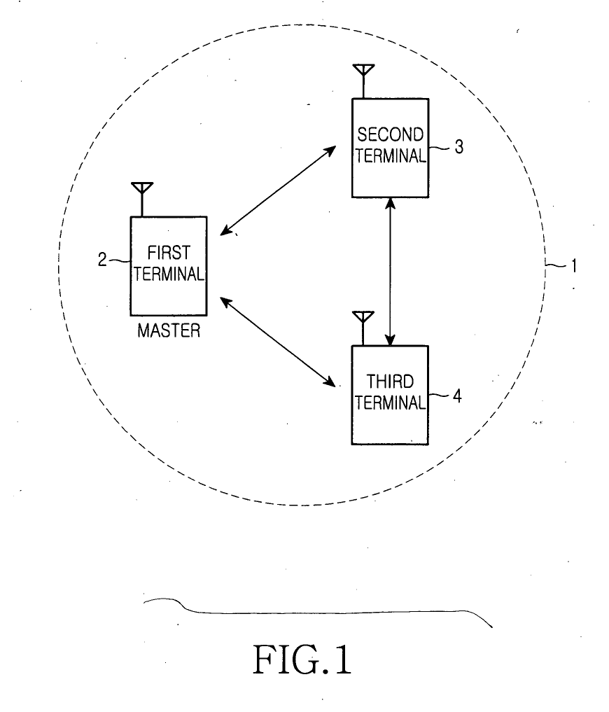

FIG. 1 is a view illustrating a configuration of a system for a multi-user game which can be played by users of different mobile terminals using a local area network (for example, Bluetooth) according to an embodiment of the present invention. As illustrated in FIG. 1, the Bluetooth game system supports point-to-point and point-to-multipoint connections. A collection of devices sharing the same channel and having the same implementations is called a piconet 1. That is, a piconet comprises a collection of devices connected via Bluetooth technology in an ad hoc fashion. FIG. 1 illustrates three devices, i.e., first to third mobile terminals 2, 3 and 4, respectively, connected into one piconet 1. One of the three devices (for example, the first mobile terminal 2) acts as a master and the others (for example, the second and third mobile terminals 3 and 4) act as slaves.

The devices go through a series of modes to form the piconet 1. Before any connections are created, all of the devices are in a standby mode. In the standby mode, the devices listen periodically for new messages, for example, every 1.28 seconds. If any device (for example, the first mobile terminal 2) wishes to make a connection to another device, it becomes a master and sends out an inquiry/page message. Devices assigned an 8-bit park member address will enter a park mode at this time. Devices (the second and third mobile terminals 3 and 4) communicating with the master (the first mobile terminal 2) are assigned a 3-bit active member address, creating the piconet 1. The address is 3 bits (with 2³=8 potential addresses), which means that up to eight devices can be linked together in a piconet (wherein one device is used as a broadcaster).

The devices with an active member address have three modes, including an active mode for communication, a hold mode, and a sniff mode (that is, a mode having lower power than an active mode). The hold and sniff modes remain on the piconet 1, but do not contribute to traffic.

To set the link between the master and the slaves, the master first sends an Inquiry containing a connection key at 625 μs intervals. The slaves (the second and third mobile terminals 3 and 4) are synchronized to the master within 2 seconds. As a result, the slaves are assigned a 3-bit active member address. The master (the first mobile terminal 2) then sends a Page message to the slaves, after which the slaves use the hopping pattern specified by the master to be synchronized to the master. Certification follows, utilizing a random number generated by the master and an exclusive OR (XOR) with the slaves' MAC addresses to create an encryption key. Upon completion of the certification, a dedicated key is passed to enter the next phase of data transmit/receive.

The first mobile terminal 2, acting as the master in the piconet 1, controls the traffic on the channel. Multiple independent and unsynchronized piconets can be connected to form a scatternet. Users of each piconet in the scatternet have a single 1 MHz hopping channel. The first mobile terminal 2 that acts as a master in one piconet, can participate in other piconets as a slave. Similarly, the second and third mobile terminals 3 and 4 can act as masters in other piconets.

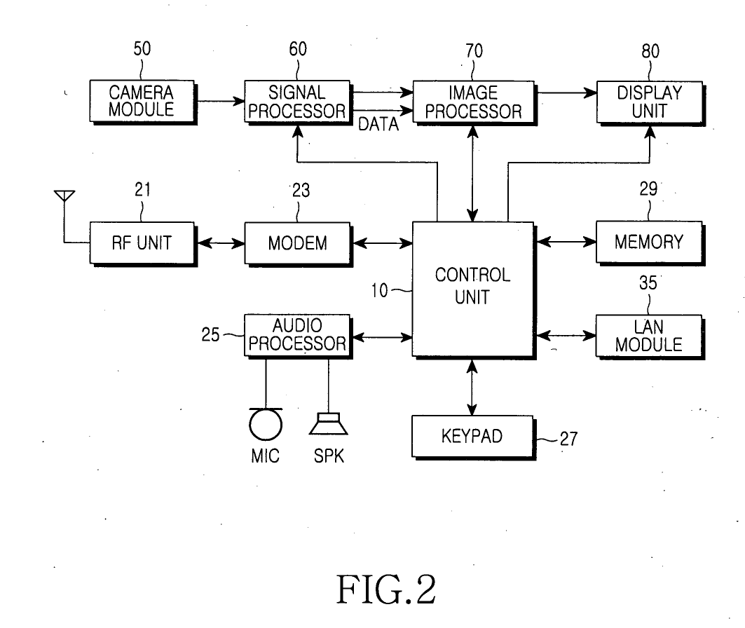

FIG. 2 is a block diagram of a mobile terminal 2, 3 or 4 according to an embodiment of the present invention. Referring to FIG. 2, the mobile terminal comprises a control unit 10, an RF unit 21, a modem 23, an audio processor 25, a keypad 27, a memory 29, a LAN module 35, a cameral module 50, a signal processor 60, an image processor 70 and a display unit 80. The mobile terminal can further comprise a microphone (MIC) and a speaker (SPK).

Referring to FIG. 2, the mobile terminal comprising the LAN module 35 further comprises the RF unit 21 for performing a wireless communication function of the mobile terminal. The RF unit 21 comprises an RF transmitter for performing upward conversion and amplification of the frequency of a transmitted signal, and an RF receiver for amplifying a received signal with low noise and performing downward conversion of the frequency of the signal.

The modem 23 comprises a transmitter for coding and modulating a signal which is being transmitted, and a receiver for demodulating and decoding a signal which is being received.

The audio processor 25 may comprise a codec which comprises a data codec for processing packet data and an audio codec for processing an audio signal such as a speech signal. The audio processor 25 converts a digital audio signal output from the modem 23 into an analog signal through the audio codec and reproduces the analog signal. Also, the audio processor 25 converts an analog audio signal generated from the microphone MIC into a digital audio signal and transmits the digital audio signal to the modem 23. The codec can be provided as an independent element or can be included in the control unit 10.

The keypad 27 is provided with keys for inputting digits and characters, and is provided with function keys for setting up various functions. The key input section 27 may also comprise a game start key, a game end key and a game information save key to implement a game function using a LAN according to embodiments of the present invention.

The memory 29 may comprise a program memory and a data memory. The program memory stores programs for controlling general operations of the mobile terminal. The data memory temporarily stores data generated during implementation of the above programs. Also, the memory 29 stores game information generated during a game using a LAN according to embodiments of the present invention.

The LAN module 35 can comprise Bluetooth, IrDA, UWB, or any suitable technology, but preferably comprises Bluetooth. Bluetooth operating at a high frequency of, for example, 2.4 GHz can transmit data even in areas with obstacles, using up to 79 channels. In a first example, a maximum power consumption is 30 mA during data communication and under 0.3 mA during standby.

The control unit 10 controls the overall operations of the mobile terminal. The control section 10 may comprise the modem 23 and the codec. When a game key is pressed to play a multi-user game using a LAN according to embodiments of the present invention, the control unit 10 controls the LAN module 35 to set a connection between mobile terminals participating in the game, and transmits game information generated during the implementation of the game to each mobile terminal. Also, the control unit 10 controls the memory 29 to store game information during the implementation of the game. Under the control of the control unit 10, the memory 29 and the LAN module 35 can then apply the stored game information for the next round of game play.

The camera module 50 is used to photograph an object. The camera module 50 comprises a camera sensor for converting a photographed optical signal into an electrical signal. The camera sensor can comprise any number of devices, such as a charge coupled device (CCD) sensor.

The signal processor 60 converts an analog image signal output from the camera module 50 into an image signal. The signal processor 60 can comprise any number of devices, such as a digital signal processor (DSP).

The image processor 70 generates picture data for displaying an image signal output from the signal processor 60. The image processor 70 adjusts image signals received under the control of the control unit 10 to conform to the features, such as size and resolution, which are displayable on the display unit 80, and outputs the adjusted image data. In doing so, the image processor 70 compresses the image data or restores the compressed image data to the original image data. In addition, the image processor 70 transmits a start address value of the image data output to the display unit 80, or changes the start address value and sends the changed value under the control of the control unit 10.

The display unit 80 displays image data output from the image processor 70. The display unit 80 can comprise a liquid crystal display (LCD) comprising an LCD controller, a memory for storing image data and an LCD device. When the LCD is a touch screen, it can further serve as an input section together with the keypad 27. The display unit 80 includes an image data display for outputting image data.

Referring to FIG. 2, if a user (or caller) sets an outgoing call mode after dialing by using the keypad 27, the control unit 10 will detect the mode and will process the dialed information received through the modem 23. The control unit 10 converts the dialed information into an RF signal through the RF unit 21 and outputs the RF signal. A reply signal generated from a recipient is detected by the RF unit 21 and the modem 23. The audio processor 25 then forms a voice communication path so that the user can communicate with the recipient.

When detecting an incoming call, the control unit 10 controls the audio processor 25 to generate a ringing signal. When the user replies to the incoming call, the control unit 10 detects the reply and controls the audio processor 25 to form a voice communication path so that the user can receive the incoming call. Although voice communications in the incoming or outgoing call mode have been described, the control unit 10 can also perform data communications to receive or transmit packet data or image data. In a standby mode or a messaging mode, the control unit 10 displays text data processed by the modem 23 on the display unit 80.

When a user of the mobile terminal presses a game key provided on the keypad 27 to play a multi-user game using a LAN, the control unit 10 of the mobile terminal controls the LAN module 35 and the memory 29 to set a connection to other terminals to implement the game. When the game is over, the control unit 10 controls the LAN module 35 to send game information generated during the game to each mobile terminal that has participated in the game. Also, the control unit 10 controls the memory 29 to store the game information.

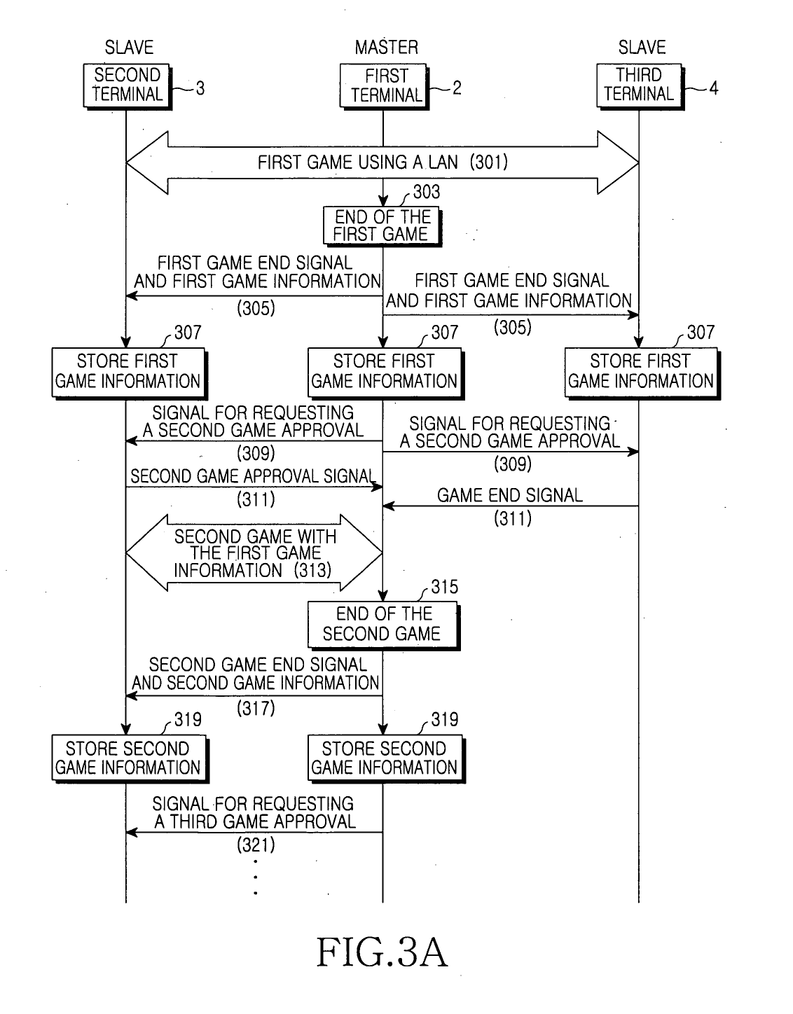

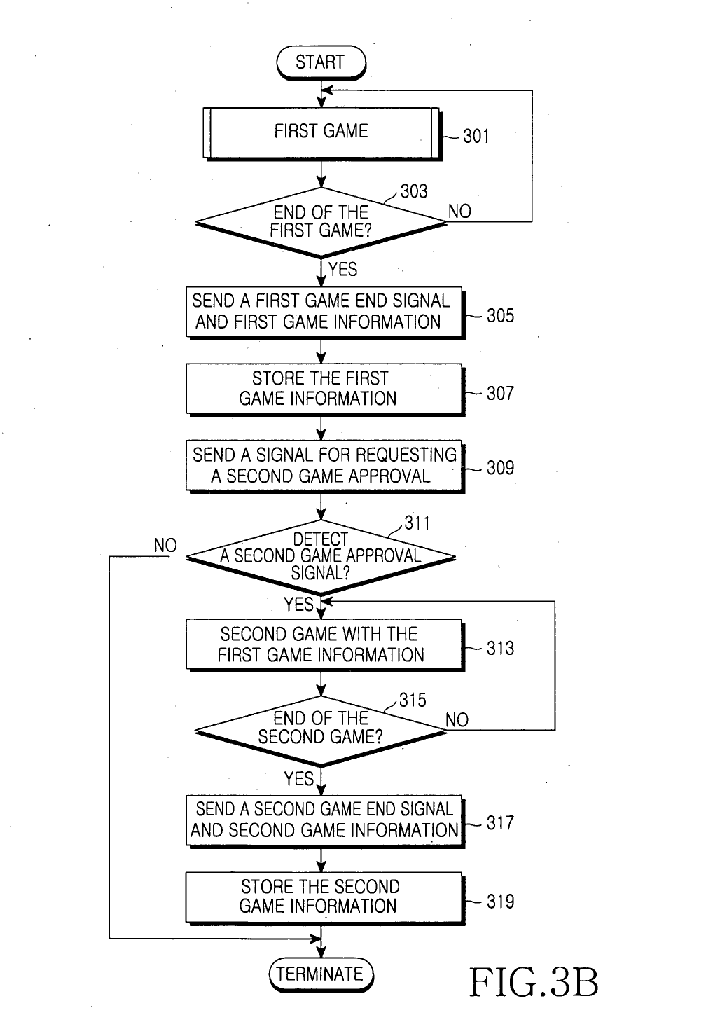

FIG. 3A is a signal exchange flow chart illustrating a process for sending game information to each mobile terminal that has participated in a game using a LAN and for storing the game information according to an embodiment of the present invention. FIG. 3B is a flow chart illustrating a process for exchanging game information between each mobile terminal that has participated in the game and for storing the game information. Hereinafter, the process for sending and storing game information will be explained in detail with reference to FIGS. 3A and 3B. When the user of the first mobile terminal 2 inputs a request for a link to the second and third mobile terminals 3 and 4 to participate in a multi-user game using a LAN at step 301, the first mobile terminal 2 in the standby mode sends an Inquiry containing a connection key at 625 μs intervals. The second and third mobile terminals 3 and 4 are synchronized to the first mobile terminal 2 within 2 seconds and are assigned a 3-bit active member address. The second and third mobile terminals 3 and 4 then enter the page/inquiry scan state. In a piconet, the first mobile terminal 2 that has requested the link for a game acts as a master and the second and third mobile terminals 3 and 4 act as slaves.

After receiving a page message from the master terminal 2, the slave terminals 3 and 4 are synchronized using the hopping pattern specified by the master terminal 2. Certification follows the synchronization. Upon completion of certification, a dedicated key is passed to transmit or receive data for a game (hereinafter referred to as “the first game”). When a LAN game mode is established through the above procedure, the first to third mobile terminals 2, 3 and 4 can begin the first game. Game information generated during the implementation of the first game may be maintained or changed. The game information comprises each player's ID (for example, a mobile phone number, mobile phone user's name, user's image and/or icon), a score or level obtained in the game, game start/end times and any game condition changed during the game.

When the first game is over or ended at step 303, the first mobile terminal 2 acting as the master transmits a signal informing of the end of the first game and of the game information generated during the first game to the second and third mobile terminals 3 and 4 acting as the slaves at step 305. The master terminal 2 stores the transmitted first game information and, at the same time, the slave terminals 3 and 4 store the received first game information at step 307.

Subsequently, when the master terminal 2 sends a signal for requesting approval or rejection of a second game at step 309, the slave terminals 3 and 4 respond to the request by sending either an approval signal or a rejection (or end) signal for the second game to the master terminal 2. It is assumed for illustration purposes in FIGS. 3A and 3B that the second mobile terminal 3 will participate in the second game whereas the third mobile terminal 4 will not.

When the third mobile terminal 4 sends a game end signal to the master terminal 2 at step 311, the master terminal 2 then outputs a signal informing of the third mobile terminal's 4 cancellation of the game mode, and sends the signal to the second mobile terminal 3. The signal can be either a voice message or a message popup window. I

If the second mobile terminal 3 sends an approval signal for the second game at step 311, the master terminal 2 and the second mobile terminal 3 as a slave will implement the second game with the application of the stored first game information at step 313. When the second game is over or ended at step 315, the first mobile terminal 2 acting as the master transmits a signal informing of the end of the second game and of the game information generated during the second game to the second mobile terminal 3 acting as the slave at step 317. The master terminal 2 then stores the transmitted second game information and, at the same time, the slave terminal 3 stores the received second game information at step 319.

For the third mobile terminal 4 that has not participated in the second game, the first game information is maintained. For the first and second mobile terminals 2 and 3 that have participated in the second game, the second game information replaces the stored first game information.

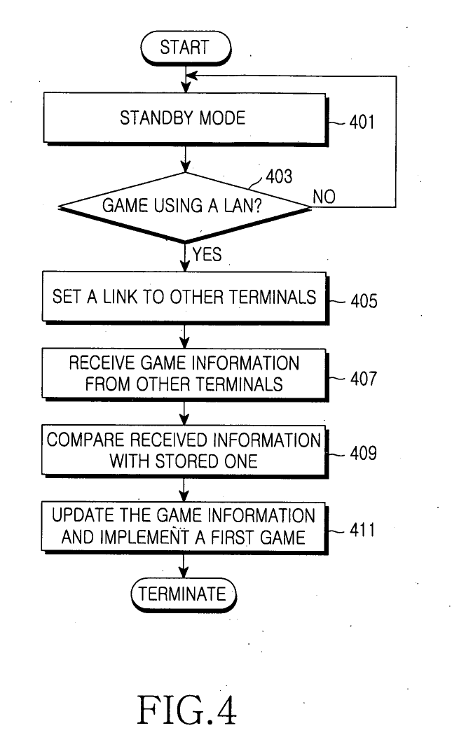

FIG. 4 is a flow chart illustrating a process for implementing a game function on a mobile terminal according to an embodiment of the present invention. The process for implementing a game function (for example, receiving game information) on multiple mobile terminals and for sending and storing game information will now be described in greater detail with reference to FIGS. 3B and 4.

When a user of a mobile terminal with the LAN module 35 presses a game mode key in the standby mode at step 401, the control unit 10 of the master mobile terminal detects the game mode key pressing at step 403 and controls the LAN module 35 to set a communication link to other terminals at step 405. The process for setting a communication link has been described above in conjunction with FIG. 1. When the LAN module 35 receives game information of any other mobile terminals via the communication link, the control unit 10 detects the receipt of the game information at step 407. The control unit 10 controls the memory 29 to compare the received game information with previously stored game information at step 409 and update the game information of the other mobile terminals at step 411. Then the control unit 10 transmits or receives data for implementing a game (hereinafter referred to as “the first game”). When a LAN game mode is established through the above procedure, the linked mobile terminals can then implement the first game at step 301 of FIGS. 3A and 3B.

When the first game is over, the control unit 10 of the master terminal detects the end of the game at step 303 and controls the LAN module 35 to transmit a signal informing of the end of the first game and of the game information generated during the first game to the slave terminals that have participated in the first game at step 305. The control unit 10 of the master terminal then controls the memory 29 to store the transmitted first game information at step 307. Also, the control unit 10 controls the LAN module 35 to send a signal for requesting approval for a second game to the slave terminals that have participated in the first game at step 309. When a second game approval signal is received from any slave terminal through the LAN module 35, the control unit 10 detects the signal at step 311 and implements the second game with the application of the first game information at step 313.

When the second game is over, the control unit 10 of the master terminal detects the end of the second game at step 315 and controls the LAN module 35 to transmit a signal informing of the end of the second game and of the second game information to the slave terminal that has participated in the second game at step 317. The control unit 10 of the master terminal then controls the memory 29 to store the second game information at step 319.

When a game end signal is received from any slave terminal that has participated in the first game at step 311, the control unit 10 of the master terminal outputs a signal informing of the slave terminal's cancellation of the game mode and sends the signal to all other slave terminals that participate in the second game. If any terminal participating in the second game is disconnected due to an incoming call, low battery status or deviation from the piconet area, the master terminal further outputs a signal informing of the disconnected condition to all other terminals in the second game. The signal can be either a voice message or a message popup window.

As described above, when a game implemented using a LAN is ended or over, game information generated during the game is transmitted to each mobile terminal that has participated in the game and is stored, to then be applied for the next round of game play, thereby arousing more interest among the game participants.

Although exemplary embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A method for implementing a multi-user game function on a plurality of mobile terminals equipped with a local area network (LAN) module, which comprises the steps of:
detecting when a key for playing a multi-user game using a LAN is pressed and, in response, setting a connection between said plurality of mobile terminals and implementing the game function;
sending game information generated during the game to each mobile terminal and storing the game information; and
applying the stored game information for a next round of game play.

2. The method as claimed in claim 1, wherein said game information comprises at least one of each player's ID, mobile phone number, score, level obtained, items obtained, game start/end times and game conditions changed during the game.

3. The method as claimed in claim 1, wherein the step of applying the stored game information for the next round of game play comprises the steps of:
receiving the game information from mobile terminals that are to participate in the next round of game play;
comparing the received game information with the stored game information to update the game information; and
applying the updated game information for the next round of game play.

4. The method as claimed in claim 1, wherein said LAN comprises at least one of Bluetooth, Infrared Data Association (IrDA) and Ultra Wide Band (UWB) implemented LAN.

5. The method as claimed in claim 1, wherein the step of setting a connection between said plurality of mobile terminals comprises the steps of:
sending from a master terminal an Inquiry containing a connection key;
synchronizing at least one slave terminal to the master terminal, wherein the slave terminals are assigned an active member address;
sending from the master terminal a Page message to the slave terminals, after which the slave terminals use a hopping pattern specified by the master terminal to be synchronized to the master terminal; and
certifying by using a random number generated by the master terminal and an exclusive OR (XOR) with a slave terminals' MAC address to create and pass an encryption key.

6. An apparatus for implementing a multi-user game function on a plurality of mobile terminals equipped with a local area network (LAN) module, comprising:
a keypad comprising at least one of a game start key, a game end key and a game information save key to implement a game function using a LAN;
a memory for storing game information generated during a game using a LAN;
a LAN module; and
a control unit for detecting when the game key is pressed to play a multi-user game using a LAN and for controlling the LAN module to set a connection between mobile terminals participating in the game.

7. The apparatus as claimed in claim 6, wherein the control unit is configured to transmit game information generated during the implementation of the game to each mobile terminal.

8. The apparatus as claimed in claim 6, wherein the control unit is further configured to control the memory to store game information during the implementation of the game.

9. The apparatus as claimed in claim 6, wherein the control unit is further configured to apply the stored game information for a next round of game play.

10. A computer program embodied on a computer-readable medium for implementing a multi-user game function on a plurality of mobile terminals equipped with a local area network (LAN) module, comprising:
a first set of instructions for detecting when a key for playing a multi-user game using a LAN is pressed and, in response, setting a connection between said plurality of mobile terminals and implementing the game function;
a second set of instructions for sending game information generated during the game to each mobile terminal and storing the game information; and
a third set of instructions for applying the stored game information for a next round of game play.

11. The computer program embodied on a computer-readable medium as claimed in claim 10, further comprising:
a fourth set of instructions for receiving the game information from mobile terminals that are to participate in the next round of game play;
a fifth set of instructions for comparing the received game information with the stored game information to update the game information; and
a sixth set of instructions for applying the updated game information for the next round of game play.

12. The computer program embodied on a computer-readable medium as claimed in claim 10, wherein said game information comprises at least one of each player's ID, mobile phone number, score, level obtained, items obtained, game start/end times and game conditions changed during the game.
